(19) United States
(12) Patent Application Publication
(10) Pub. No.: US 2009/0184016 A1
(43) Pub. Date: Jul. 23, 2009

(54) Dishware Guard

(76) Inventor: Jennifer McKerley, Los Alamos, NM (US)

Correspondence Address: PEACOCK MYERS, P.C., 201 THIRD STREET, N.W., SUITE 1340, ALBUQUERQUE, NM, 87102, US

(21) Appl. No.: 12/355,503

(22) Filed: Jan. 16, 2009

Related U.S. Application Data
(60) Provisional application No. 61/021,524, filed on Jan. 16, 2008.

(51) Int. Cl. B65D 85/48; B23P 19/04

(52) U.S. Cl. 206/453; 29/700

(57) ABSTRACT

Flexible, freestanding guards for delicate dishware and/or other items. These guards are especially for use in dishwasher cleaning of dishware and/or packing, storing and/or shipping, and the method therefor.

### CROSS-REFERENCE TO RELATED APPLICATIONS

This application claims priority to and the benefit of the filing of U.S. Provisional Patent Application Ser. No. 61/021,524, entitled “Dishware Guard”, filed on Jan. 16, 2008, and the specification thereof is incorporated herein by reference.

### BACKGROUND OF THE INVENTION

### Field of the Invention

### Technical Field

Embodiments of the present invention relate to flexible, freestanding guards for delicate dishware and/or other items especially useful in dishwashers and the like and the method therefore.

Prior art devices are available that prevent stemware from overturning, but they do not offer protection from lateral damage.

### BRIEF SUMMARY OF THE INVENTION

Embodiments of the present invention relate to flexible, freestanding guards for delicate dishware and the like.

An embodiment of the present invention provides for a guard for dishware that has a flexible material, at least one component engageable with the dishware, and the guard preventing contact of the dishware with another object.

Components of the guard may comprise an opening and an edge detail, the edge that has a smooth edge, a rounded edge, a jagged edge, a concave edge, a convex edge, a straight edge, a bottleneck edge, and/or a rough edge.

Additionally, the guard may optionally comprise a rib and/or a channel. The flexible material may comprise a cushioning material. The guard may be of at least one shape selected from the group consisting of a triangle, rectangle, square, circle, and other geometric shape.

The another object may be a dishwasher, a box part, and/or dishware.

Another embodiment of the present invention provides a method for guarding dishware that includes but is not limited to placing dishware in a container, inserting at least one dishware guard in proximity to the dishware and preventing contact of the dishware with another object, and protecting the dishware with the dishware guard.

The method may further comprise the container including but not limited to a dishwasher, box, shipping container, and/or sink.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings 1 through 9, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 illustrates a face view of an embodiment of the present invention;

FIG. 2 illustrates an edge view of the present invention;

FIG. 3 illustrates a face view of an alternative embodiment of the present invention.

FIG. 4 illustrates an edge view of an alternative embodiment of the present invention;

FIG. 5 illustrates an edge top view of an alternative embodiment of the present invention;

FIG. 6 illustrates an edge view of an alternative embodiment of the present invention;

FIG. 7 illustrates a face view of an alternative embodiment of the present invention;

FIG. 8 illustrates a face view of an alternative embodiment of the present invention; and

FIG. 9 illustrates a face view of an alternative embodiment of the present invention.

### DETAILED DESCRIPTION OF THE INVENTION

Embodiments of the present invention preferably provide a flexible, freestanding guard for delicate dishware or other items, including but not limited to ceramic, porcelain, glass, plastic, metal, and crystal, to protect them from chipping and other movement damage, especially useful during operation of a dishwasher and to discourage overturning of dishware or stemware.

Embodiments of the present invention are not a sponge or absorbent material.

Alternative embodiments of the invention can optionally be used as packing material for shipping dishware and other delicate items. When storing dishware or stacking dishware on shelves, the guards can be used to provide protective layers between dishware. The smaller embodiments of the invention can be placed between glasses or dishware that are stacked one inside the other, preventing glasses from becoming stuck together. Additionally, embodiments of the present invention include but are not limited to use as shipping material and/or subsequent use in a dishwasher, or other uses, providing an eco-friendly multiple use apparatus.

Top dishwasher trays generally provide a cup/glass rack and posts where cups and bowls can be placed over, and that small plates can be placed between. Delicate dishware must be spread out on the cup rack with empty spaces between to prevent items from touching and causing chipping. If placed in the center of a top rack of a dishwasher, glasses, cups, and bowls must generally be positioned over posts, leaving an empty post and space between objects to prevent damage. Both of the above placements of dishware require space to be wasted in the dishwasher tray. The above arrangements also allow lighter weight dishware to lift up and turn over.

Embodiments of the flexible dishware guard of the present invention offer protection from lateral damage to dishware placed closely together, thus using dishwasher space more efficiently. Because dishware can be placed closely together, dishes are less likely to overturn. Also, the ribbing and channeling on embodiments of the present invention and the rubberized-type surface apply friction or resistance to dishware that moves against the guards during washing operations and substantially prevents overturning. The ribbing, openings and channeling also facilitate water movement and drainage. The dishware guard of the present invention preferably prevents overturning of dishware and provides protection from chipping by adjacent dishware.

Alternatively, embodiments can be rigid dish guards that can be attached to a dishwasher post to stabilize the guard and the adjacent dishware.

Embodiments of the present invention include but are not limited to flexible dishware guards which can be placed freestanding and vertically between items of dishware without being attached to a post. However, openings and/or holes in the face of the guards optionally allow the guards to be secured to a post or posts when needed to better position the guards to protect standing plates, bowls, saucers, platters, etc. Additionally, the openings and/or holes can facilitate water movement and cleaning of dishware. Because the guard can be used freestanding or attached, it offers more versatility. The guard is flexible and able to be curved or shaped around the outsides of dishware or to conform to the shapes of dishes when placed between two standing items of dishware. It can be used in the bottom or top dishware trays.

The term “dishware” as used herein includes, but is not limited to objects from which people eat and/or serve food, drink and/or serve drinks, and/or cutlery. The term “dishware” also includes but is not limited to laboratory dishes and/or instruments, artwork, ceramics, plastics, metals, medical instruments, industrial glassware, institutional/professional cookware, circuit boards, glass, glassware, jewelry, gems and any other item that requires special handling while washing and/or packing and/or being stored and/or shipped.

The term “guard” as used herein includes but is not limited to materials used to shield from harm and/or protect.

Embodiments of the present invention are preferably made of silicone, synthetic rubber, plastic or other dishwasher safe, non-rigid or rigid material, or composite materials or any combination thereof. The guards are preferably, durable, thick, and heavy enough to stay in place during washing operations without being attached to a post (e.g. items in a top washer tray). Embodiments of the dishware guard comprise substantially any shape and size, dimension, length, width, flexibility, surfaces, texture, and/or decoration suitable to guard any kind of dishware or the like. The guard may be any color.

Sizes of the face of the guard preferably range from between approximately 18″×12″ to 25″×15″, more preferably range from between approximately 1″×1″ to between approximately 5″×10″, but are not limited to that range.

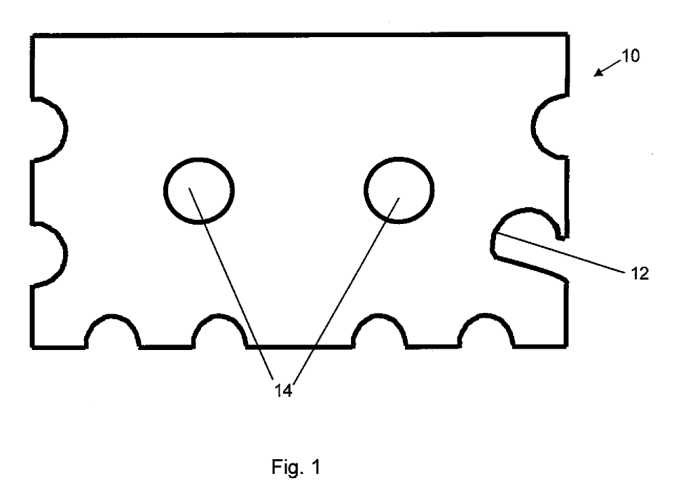

In the drawings, FIGS. 1 through 9 illustrate non-limiting examples of possible shapes of embodiments of the present invention.

As illustrated in FIG. 1, an embodiment of the present invention comprises flexible guard 10 that is rotatably and/or moveably placed between dishware, especially useful for dishwashers. Flexible guard 10 comprises edge 12 that may fit around dishwasher posts or edges and/or may be interlocking for packing and/or shipping. Flexible guard 10 may optionally comprise openings 14 that may be secured to dishwasher posts and/or allow water to reach the dishes.

Preferred embodiments of the invention comprise edge thicknesses that range from between approximately 1/16 inches to approximately ½ inches however, the thickness is not limited to this range, and can be thicker or thinner. Likewise, embodiments of the present invention may comprise any size, thickness, or shape for accommodating dishware.

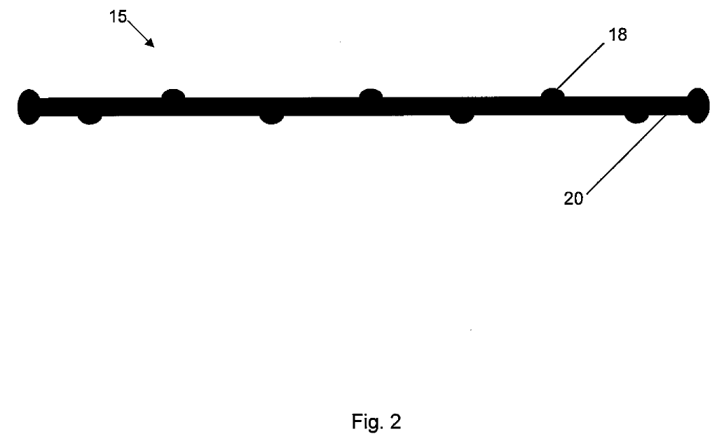

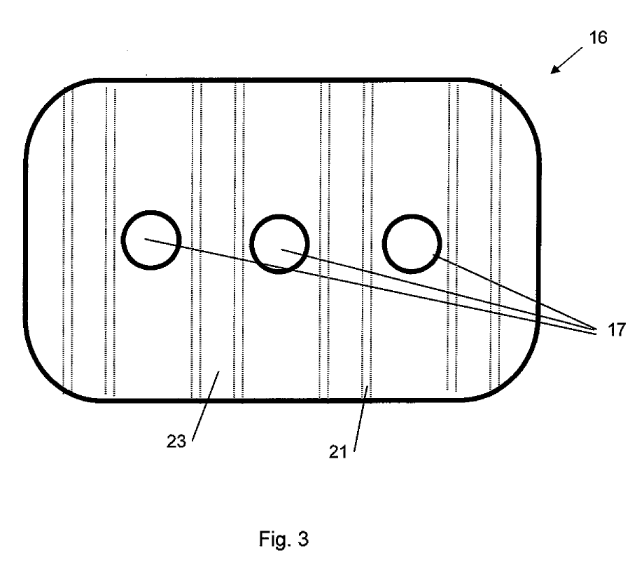

FIG. 2 illustrates an edge view of guard 15. FIG. 3 illustrates a face view of guard 16 with openings 17. FIGS. 2 and 3 show types of ribbing and channeling. Embodiments comprise ribbing 18, 21 (respectively) and channeling 20, 23 (respectively) on guards 15, 16 (respectively) regardless of size. Any surfaces or arrangements of ribbing and channeling may be used. Ribbing 18, 21 and channeling 20, 23 may be used for stability of the dishware. Optionally, ribbing 18, 21 and channeling 20, 23 may be used for a plurality of uses including but not limited to packing stability, channeling water in the dishwasher, added protection for the dishware and for stability in a dishwasher.

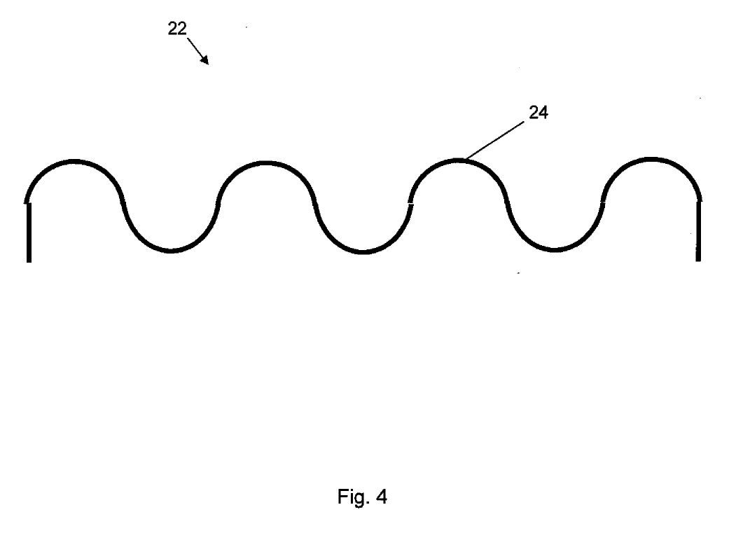

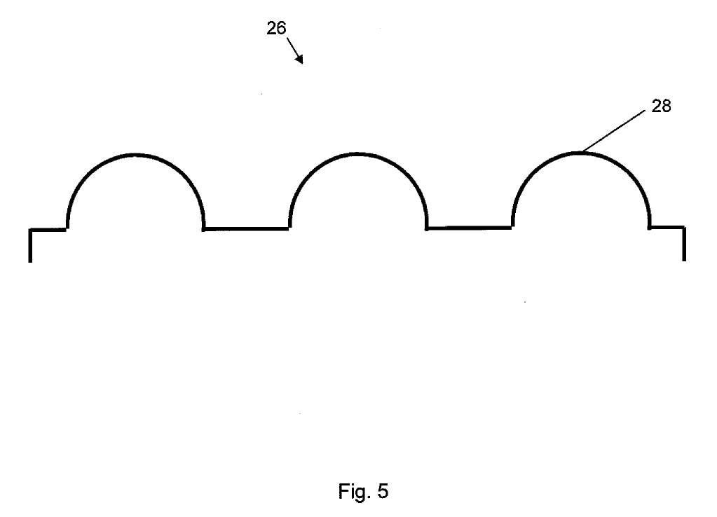

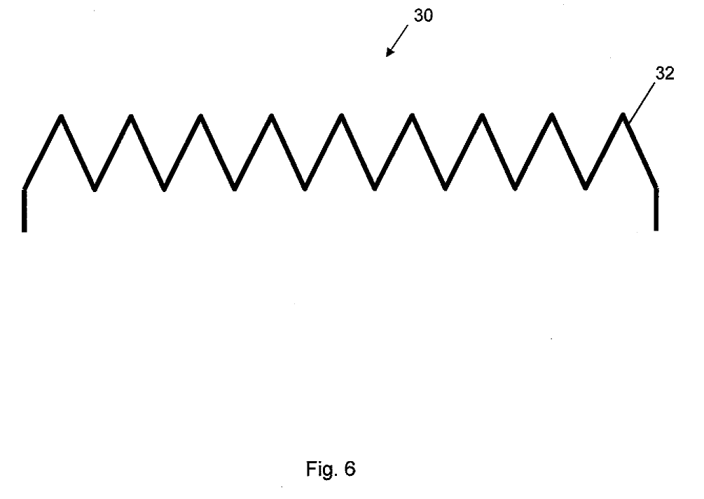

FIG. 4 illustrates a horizontal view of guard 22 and optional smooth wave edge 24. FIG. 5 illustrates a horizontal view of guard 26 with flat and rounded edge 28. FIG. 6 illustrates a horizontal view of guard 30 with jagged edges 32.

FIGS. 5 through 8 illustrate some variations in the edge configuration of embodiments of the present invention. The types of edging shown may appear on any edge of the present invention. Any notched, indented, and irregular edge configurations, not shown, may be used on embodiments of the present invention to accommodate placement on vertical and horizontals wires or runners of different types of dishwasher trays. Additionally, any smooth, straight, rounded or other edges may be used for any combination of edges appropriate to the use of the guard.

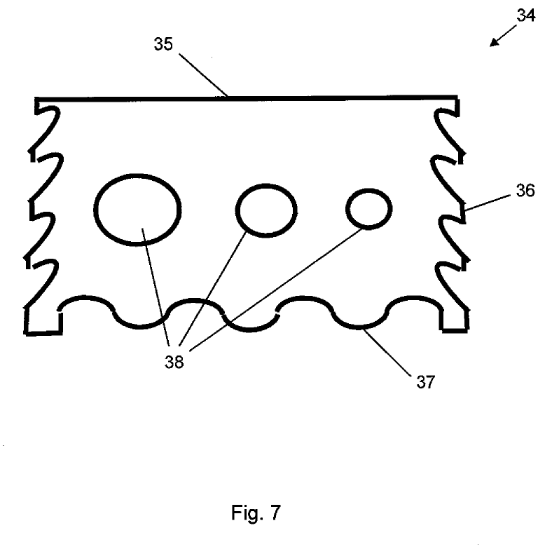

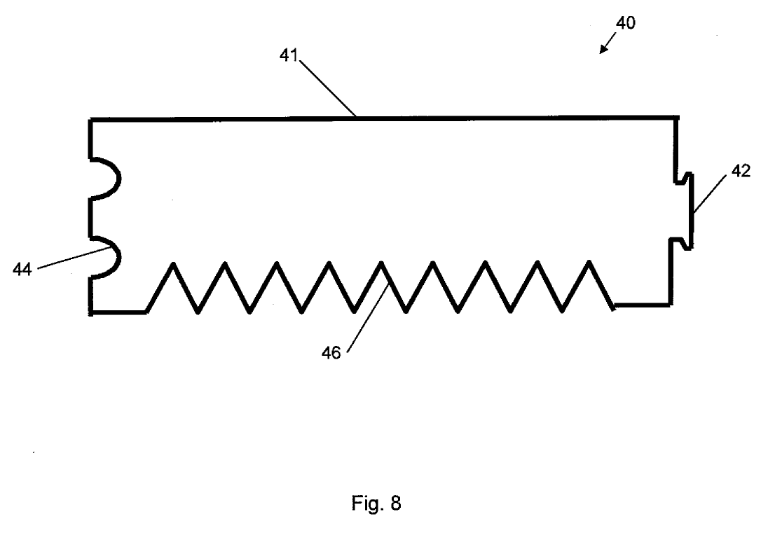

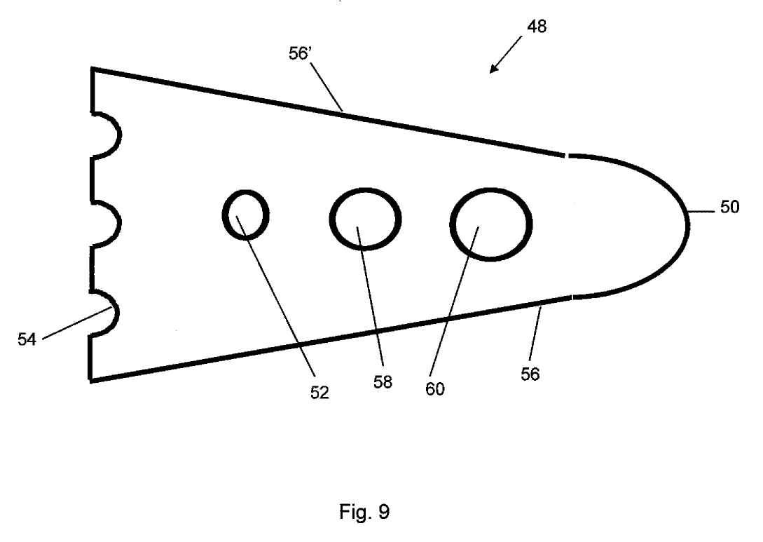

FIG. 7 illustrates guard 34 with wave edge 36, straight edge 35 and convex edge 37 and openings 38. FIG. 8 illustrates guard 40 with bottleneck-like edge 42, concave edge 44, straight edge 41 and jagged edge 46. FIG. 9 illustrates guard 48 with smooth rounded edge 50, straight edges 56, 56′ concave edge 54 and openings 52, 58 and 60. FIGS. 1 through 9 illustrate a few of the numerous possible combinations of edges, sizes, openings and added qualities of the present invention which allow the invention to be adjusted to any situation where a dishwasher is used, and/or dishware is stored, packed, shipped or any combination thereof.

FIG. 9 illustrates an embodiment of the invention with different size openings 52, 58 and 60. Embodiments of the present invention include any arrangement, pattern, and/or size of openings to accommodate guards being secured to one or more posts to facilitate placement between standing dishware. Alternative embodiments use the openings for ventilation during storage and shipping. Embodiments may use openings for fluid drainage in a dishwasher.

While embodiments of the invention are directed to a dishware guard, the invention is also useful for any process and/or device that requires a protective separation apparatus and method for separating and/or washing fragile components or items.

### INDUSTRIAL APPLICABILITY

The invention is further illustrated by the following non-limiting example.

### Example 1

A set of dishware guards were made using flexible rubber or similar materials and were constructed in accordance with the above specification. The dishware guards were constructed in varying lengths and sizes. The dishware guards were placed between fragile dishes and between ceramic pots in a household dishwasher. The dishes and pots were cleaned and displayed no chipping, cracking or other evidence of any destruction.

Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above and/or in the attachments, and of the corresponding application(s), are hereby incorporated by reference.

What is claimed is:

1. A guard for dishware comprising:
a flexible material;
at least one component engageable with the dishware; and
said guard preventing contact of the dishware with another object.

2. The guard of claim 1 wherein said component comprises an opening.

3. The guard of claim 1 wherein said component comprises an edge detail.

4. The guard of claim 3 wherein said edge detail comprises a smooth edge.

5. The guard of claim 3 wherein said edge detail comprises a rounded edge.

6. The guard of claim 3 wherein said edge detail comprises a jagged edge.

7. The guard of claim 3 wherein said edge detail comprises a concave edge.

8. The guard of claim 3 wherein said edge detail comprises a convex edge.

9. The guard of claim 3 wherein said edge detail comprises a straight edge.

10. The guard of claim 3 wherein said edge detail comprises a bottleneck edge.

11. The guard of claim 3 wherein said edge detail comprises a rough edge.

12. The guard of claim 1 wherein said component comprises a rib.

13. The guard of claim 1 wherein said component comprises a channel.

14. The guard of claim 1 wherein said flexible material comprises a cushioning material.

15. The guard of claim 1 wherein said guard comprises at least one shape selected from the group consisting of a triangle, rectangle, square, circle, and other geometric shape.

16. The guard of claim 1 wherein the another object comprises a dishwasher.

17. The guard of claim 1 wherein the another object comprises a box part.

18. The guard of claim 1 wherein the another object comprises another dishware.

19. A method for guarding dishware comprising:
placing dishware in a container;
inserting at least one dishware guard in proximity to the dishware and preventing contact of the dishware with another object; and
protecting the dishware with the dishware guard.

20. The method of claim 19 wherein the container comprises a dishwasher.

21. The method of claim 19 wherein the container comprises a box or shipping container.

22. The method of claim 19 wherein the container comprises a sink.

23. The method of claim 20 further comprising facilitating water movement about the dishware guard.
